(19) United States
(12) Patent Application Publication
(10) Pub. No.: US 2026/0067144 A1
(43) Pub. Date: Mar. 5, 2026

(54) METHODS FOR REFERENCE SIGNAL CONFIGURATIONS FOR POSITIONING OF LOW-POWER HIGH ACCURACY POSITIONING DEVICES

(71) Applicant: Huawei Technologies Co., Ltd., Shenzhen (CN)

(72) Inventor: Anthony Lo, Schaumburg, IL (US)

(21) Appl. No.: 19/385,732

(22) Filed: Nov. 11, 2025

Related U.S. Application Data
(63) Continuation of application No. PCT/US2024/028018, filed on May 6, 2024.
(60) Provisional application No. 63/501,830, filed on May 12, 2023.

(51) Int. Cl. H04L 27/26; H04L 5/00; H04W 76/27; H04W 76/40

(52) U.S. Cl. CPC H04L 27/261; H04L 5/0044; H04W 76/27; H04W 76/40

(57) ABSTRACT

According to embodiments, a user equipment (UE) receives a sounding reference signal (SRS) configuration. The SRS configuration includes a first SRS configuration that is used by the UE in a radio resource control (RRC) connected state for SRS transmission and a second SRS configuration that is usable by the UE in an RRC inactive state for SRS transmission with a plurality of cells within a positioning validity area. The UE, while in the RRC connected state, performs a first SRS transmission with a first cell of the plurality of cells based on the first SRS configuration. The UE determines that the UE is in the RRC inactive state. The UE, while in the RRC inactive state, performs a second SRS transmission with one or more cells of the plurality of cells based on the second SRS configuration.

### CROSS-REFERENCE TO RELATED APPLICATIONS

This application is a continuation of International Application No. PCT/US2024/028018, filed on May 6, 2024 and entitled “Methods for Reference Signal Configurations for Positioning of Low-Power High Accuracy Positioning Devices,” which claims priority to U.S. Provisional Patent Application No. 63/501,830, filed on May 12, 2023 and entitled “Methods for Reference Signal Configurations for Positioning of Low-Power High Accuracy Positioning Devices,” applications of which are incorporated herein by reference in their entireties.

### TECHNICAL FIELD

The present disclosure relates generally to methods and systems for wireless communications, and, in particular embodiments, to methods and systems for reference signal configurations.

### BACKGROUND

In Fifth Generation (5G) New Radio (NR) cellular systems, downlink and uplink transmissions take place in time and frequency resources. A time and frequency resource may be allocated in a unit of a physical resource block (PRB). For NR mobile broadband (MBB) communication, in a slot, each PRB in the resource grid is defined as a span of 14 consecutive orthogonal frequency division multiplexed (OFDM) symbols in the time domain and 12 consecutive subcarriers in the frequency domain; thus, each PRB contains 12×14 resource elements (REs). Each RE is located on one OFDM symbol in the time domain and one subcarrier in the frequency domain. When used as a frequency-domain unit, a PRB is 12 consecutive subcarriers. There are 14 symbols in a slot when a normal cyclic prefix is used and 12 symbols in a slot when an extended cyclic prefix is used. The duration of a symbol is inversely proportional to the subcarrier spacing (SCS). For a {15, 30, 60, 120} kHz SCS, the duration of a slot is {1, 0.5, 0.25, 0.125} ms, respectively. Each PRB may be allocated to a control channel, a shared channel, a feedback channel, reference signals, and/or any combination thereof. In addition, some REs of a PRB may be reserved. A similar structure may be used on the sidelink (SL) as well. A communication resource may be a PRB, a set of PRBs, a code (if code division multiple access (CDMA) is used, similarly as for the physical uplink control channel (PUCCH)), a physical sequence, a set of REs, and so on.

### SUMMARY

Technical advantages are generally achieved, by embodiments of this disclosure which describe methods and apparatus.

According to embodiments, a user equipment (UE) receives a sounding reference signal (SRS) configuration. The SRS configuration includes a first SRS configuration that is used by the UE in a radio resource control (RRC) connected state for SRS transmission and a second SRS configuration that is usable by the UE in an RRC inactive state for SRS transmission with a plurality of cells within a positioning validity area. The UE, while in the RRC connected state, performs a first SRS transmission with a first cell of the plurality of cells based on the first SRS configuration. The UE determines that the UE is in the RRC inactive state. The UE, while in the RRC inactive state, performs a second SRS transmission with one or more cells of the plurality of cells based on the second SRS configuration.

In some embodiments, the SRS configuration may indicate a pathloss reference signal (RS) for positioning. The UE may determine whether the UE while in the RRC inactive state is able to accurately measure a pathloss using the pathloss RS.

In some embodiments, to perform the second SRS transmission, the UE, while in the RRC inactive state, may calculate a pathloss parameter for power control of the second SRS transmission based on that the pathloss measured using the pathloss RS is above a threshold. The UE, while in the RRC inactive state, may set the pathloss measured using the pathloss RS as the pathloss parameter for the power control of the second SRS transmission based on that the pathloss measured using the pathloss RS is accurately measured.

In some embodiments, to perform the second SRS transmission, the UE, while in the RRC inactive state, may calculating a pathloss parameter for power control of the second SRS transmission using an RS resource from a synchronization signal (SS)/physical broadcast channel (PBCH) block based on that the pathloss measured using the pathloss RS is not accurately measured.

In some embodiments, the UE, while in the RRC inactive state, may determine whether to perform the second SRS transmission over an SRS resource based on whether the UE is able to accurately measure a downlink (DL) RS. The DL RS may have a spatial relation with an SRS resource for positioning, and the DL RS is semi-persistent or periodic.

In some embodiments, the UE may be configured with one or more of: a one-to-many spatial relation in the positioning validity area, or a one-to-many pathloss relation within the positioning validity area.

In some embodiments, the one-to-many spatial relation may comprise: each positioning SRS resource within an SRS resource set being associated with at least a subset of RSs transmitted by individual base stations in the positioning validity area.

In some embodiments, the second SRS configuration may indicate a nominal transmit power parameter and a fractional power-control multiplier parameter for the positioning validity area. To perform the second SRS transmission, the UE, while in the RRC inactive state, may calculate a transmit power for each of multiple SRS resources of the second SRS transmission using the nominal transmit power parameter and the fractional power-control multiplier parameter. The multiple SRS resources may belong to multiple SRS resource sets and may be associated with multiple cells of the plurality of cells within the positioning validity area.

In some embodiments, the UE may be a low-power high accuracy positioning (LPHAP) device.

In some embodiments, the first SRS transmission may correspond to a first beam. The second SRS transmission may correspond to multiple beams.

In some embodiments, the UE may receive a downlink RS from each of multiple cells using a same beam as a transmit beam corresponding to an SRS resource of a corresponding cell. Each of the multiple cells may correspond to respective different transmit beams.

According to embodiments, a user equipment (UE) receives a sounding reference signal (SRS) configuration. The SRS configuration is usable by the UE across a positioning validity area covered by a plurality of cells. The UE establishes one or more beams for first SRS transmission by the UE at a first location covered by a first cell in the positioning validity area based on the SRS configuration. The UE moves from the first location to a second location covered by a second cell in the positioning validity area. The UE determines how to use the SRS configuration for second SRS transmission by the UE at the second location.

In some embodiments, the SRS configuration may indicate a pathloss reference signal (RS) for the positioning validity area. The UE may calculate a pathloss parameter for power control of the second SRS transmission based on whether the UE in an RRC_INACTIVE state can accurately measure a pathloss using the pathloss RS.

In some embodiments, whether the UE can accurately measure a pathloss using the pathloss RS may be based on whether the pathloss measured using the pathloss RS is above a threshold.

In some embodiments, the UE may set the pathloss measured using the pathloss RS as the pathloss parameter for the power control of the second SRS transmission based on that the pathloss measured using the pathloss RS is accurately measured.

In some embodiments, the UE may calculate the pathloss parameter for the power control of the second SRS transmission using an RS from a synchronization signal (SS)/physical broadcast channel (PBCH) block based on that the pathloss measured using the pathloss RS is not accurately measured.

In some embodiments, the SRS configuration may indicate a spatial relation for the positioning validity area. The spatial relation may be between a downlink (DL) RS and an SRS resource. The UE may determine, while the UE is in an RRC_INACTIVE state, whether to perform the second SRS transmission over the SRS resource based on whether the UE can accurately measure the DL RS.

In some embodiments, the UE may determine, while the UE is in the RRC_INACTIVE state, not to perform the second SRS transmission based on that the UE cannot accurately measure the DL RS.

In some embodiments, the DL RS may be semi-persistent or periodic.

In some embodiments, the SRS configuration may indicate a nominal transmit power parameter and a fractional power-control multiplier parameter for the positioning validity area. The UE may calculate, while the UE is in an RRC_INACTIVE state, a transmit power for the second SRS transmission using the nominal transmit power parameter and the fractional power-control multiplier parameter.

In some embodiments, the determining how to use the SRS configuration for the second SRS transmission may be performed while the UE is in an RRC_INACTIVE state.

In some embodiments, the UE may be a low-power high accuracy positioning (LPHAP) device.

In some embodiments, the plurality of cells covering the positioning validity area may include at least three cells.

In some embodiments, each cell of the plurality of cells covering the positioning validity area may correspond to a different cell identifier (ID).

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 shows an example of positioning validity areas for LPHAP devices operating in the RRC Inactive state, according to some embodiments;

FIG. 2 shows an example of uplink transmit and receive beam orientations before and after cell reselection due to device mobility, according to some embodiments;

FIGS. 3A-3C show examples of RRC parameter structures;

FIG. 3D illustrates an example of a multi-tiered SRS configuration structure for positioning, according to some embodiments;

FIG. 4 shows LPHAP device's location-independent parameters, according to some embodiments;

FIG. 5 shows LPHAP device's location-dependent parameters, according to some embodiments;

FIG. 6 illustrates an example of one-to-many spatial relation configuration method of positioning SRS resources for LPHAP devices, according to some embodiments;

FIG. 7 is a flowchart depicting a one-to-many spatial relation SRS resource configuration method of positioning SRS resources, according to some embodiments;

FIG. 8 is flowchart depicting the legacy spatial relation SRS resource configuration method of positioning SRS resources, according to some embodiments;

FIG. 9 shows a flow chart of a method performed by a UE (e.g., an LPHAP device), according to some embodiments;

FIG. 10 illustrates an example communications system, according to embodiments;

FIG. 11 illustrates an example communication system, according to some embodiments;

FIGS. 12A and 12B illustrate example devices that may implement the methods and teachings according to this disclosure; and

FIG. 13 is a block diagram of a computing system that may be used for implementing the devices and methods disclosed herein.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

In the framework of Release-18 work item about expanded and improved New Radio positioning, 3GPP introduced a new type of end-user device for positioning or localization, called a Low-Power High Accuracy Positioning (LPHAP) device, targeting Industrial Internet of Things (IIoT). Use cases of such HOT include, among others, massive asset tracking, tracking of automated guided vehicles in industrial factories, and person-localization in danger zones. Such an LPHAP device is intended to have extremely low-power consumption with battery operating lifetime up to one or more years. An LPHAP device can be in one of the Radio Resource Control (RRC) states, such as RRC Idle, RRC Inactive, or RRC Connected states. In order to conserve battery energy, the LPHAP device is required to stay in the RRC Inactive state instead of the RRC Connected state while transmitting and/or receiving reference signals for positioning. While in the RRC Inactive state, the LPHAP device needs to perform mobility procedures (e.g., cell reselection and radio access network notification area update), reception of broadcast system information, and reception of network paging.

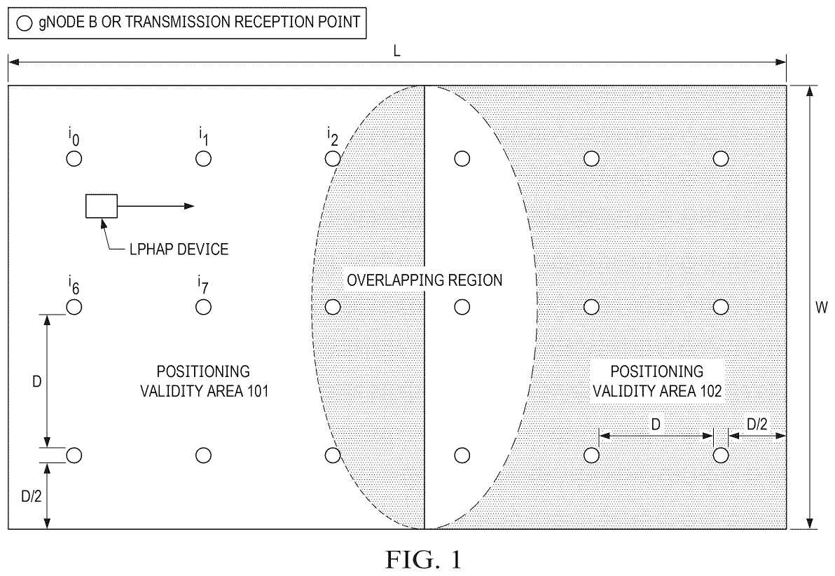

Conclusions of the evaluation results captured in 3GPP TR 38.859, which was conducted by 3GPP during the Release-18 study phase, stated that the aforementioned battery operating lifetime requirement cannot be fulfilled in the case of LPHAP device mobility. Such short lifetime is caused by frequent new configuration requests for Sounding Reference Signal (SRS) resources in which the gNodeB processes the received SRS to obtain information needed for positioning purposes. Such an SRS configuration request triggers a Random-Access Small Data Transmission (SDT) procedure whenever the current SRS configuration in the serving cell is no longer valid or cell reselection is performed. To this end, 3GPP introduced the concept of a positioning validity area, aiming at reducing battery energy consumption while supporting device mobility. Herein, a positioning area validity area includes a group of cells as illustrated in FIG. 1. For instance, a positioning validity area can be defined as a set of physical cell identities within the operator's cellular network. Such a positioning validity area allows an LPHAP device to move within the defined realm (or area) while in the RRC Inactive state maintaining the same or existing SRS resource configurations, and the device can continue to use the SRS configuration even after cell reselection without the need to request a new one, resulting in battery energy savings of LPHAP devices. FIG. 1 depicts an example deployment scenario for an indoor factory in which the lattice network layout is a W×L rectangular area (in square meters) and the base stations are uniformly spaced with a fixed Inter-Site Distance (ISD) equal to D (in meters); the area is divided into two positioning validity areas, namely positioning validity area 101 and positioning validity area 102. There may be a region where the positioning validity areas 101 and 102 overlap in FIG. 1.

Herein, the term “device” may be synonymous with the 3GPP User Equipment (UE).

In this disclosure, an LPHAP device may operate in the NR frequency band belonging to Frequency Range 1 (FR1) or Frequency Range 2 (FR2), which is specified in Clause 5.1, 3GPP TS 38.104 as presented in Table 1. Note that the term “FR2” (which is commonly known as the millimeter-wave band) refers to both FR2-1 and FR2-2 subranges.

TABLE 1
Definition of New-Radio Frequency
Ranges (Source: 3GPP TS 38.104)

| | Frequency Range Designation | | Frequency Range |
|---|---|---|---|
| FR1 | | | 410 MHz-7125 MHz |
| | FR2 | FR2-1 | 24250 MHz-52500 MHz |
| | | FR2-2 | 52600 MHz-71000 MHz |

One goal of the positioning validity area is to support mobility of LPHAP devices without triggering SRS reconfigurations, leading to a significant amount of battery energy savings. This means that the LPHAP devices are able to continue using the existing SRS configuration following cell reselection as long as the devices are within the positioning validity area. However, such an approach causes specific SRS resource parameters, which are influenced by the movement and rotation of the devices, to become invalid. To date, how to deal with such SRS resource parameters remains a key open technical issue in 3GPP. In this disclosure, a technical solution addressing the technical issue is described.

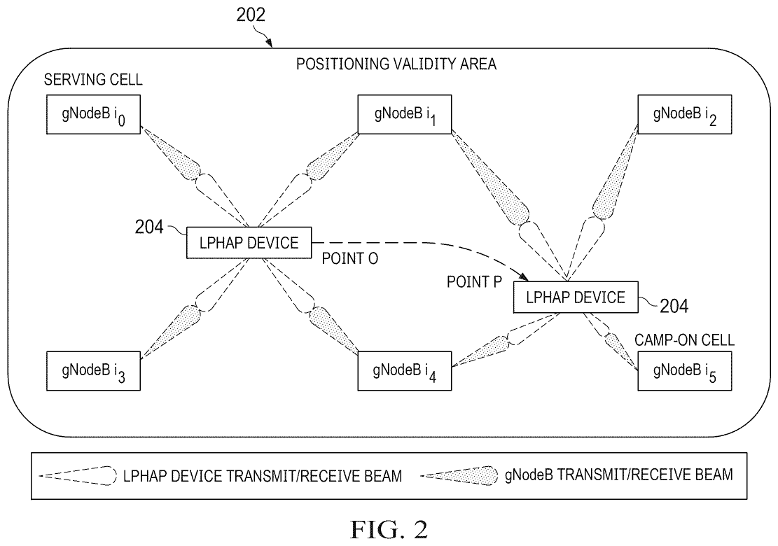

Herein the technical problem above is further elaborated in detail with an example. Assuming one LPHAP device 204 (operating in the frequency range FR2) is located in a positioning validity area 202, including six network cells, where each cell has a cellular base station gNodeB (or Transmission Reception Point (TRP)) as illustrated in FIG. 2. Initially, the LPHAP device 204 located at Point O is served by gNodeB i0 (cell i0) from which it receives an SRS resource configuration for uplink positioning only (or downlink plus uplink positioning) when making a transition from the RRC Connected state to the RRC Inactive state using the RRC Release message with a suspend indication. In addition, the LPHAP device 204 also receives a radio-access network notification area. The aforementioned SRS resource configuration comprises one SRS resource set, which in turn includes, for instance, four configured positioning SRS resources. The LPHAP device 204 transmits each of the four configured positioning SRS resources using a specific (or different) beam in a time-multiplexed manner to four gNodeBs. As depicted in FIG. 2, the spatial direction of each transmit beam for the device is different, which is directed towards the intended gNodeB; the receive beam of the intended gNodeB is aligned with the corresponding transmit beam of the device. In 3GPP terminology, a transmit beam or a receive beam may be referred to as a spatial domain transmission filter or a spatial domain reception filter, respectively.

As the LPHAP device 204 moves from Point O to Point P as illustrated in FIG. 2, it performs the cell reselection procedure and, subsequently, camps on cell i5 without informing the network as long as the selected cell is in the same radio-access network notification area. As the gNodeB i5 (camp-on cell i5) belongs to the same positioning validity area as cell i0, no SRS resource reconfiguration is needed; and the device can continue using the same SRS configuration for uplink positioning as before the cell reselection.

However, spatial relation is one RRC SRS resource parameter which depends on the physical location of the LPHAP device. A spatial relation is established between a downlink reference signal and a configured positioning SRS resource. As a consequence of device mobility, the gNodeB's receive beam and the device's transmit beam for the SRS resource can differ from the beams prior to the cell reselection. At Point P, the spatial directions of the gNode B i1 and gNodeB i4 receive beams differ from the ones when the LPHAP device 204 is at Point O. Similarly, the spatial directions of the LPHAP device 204's transmit beams directed towards gNodeB i1 and gNode B i4 are also different. Since the LPHAP device 202 does not trigger SRS resource reconfiguration after moving to Point P, gNodeB i1 and gNodeB i4 are not aware of the device's new location. To this end, the gNodeB i1 and gNodeB i4 are not able to receive the SRS transmission from the LPHAP device 204 because their receive beams are steered towards Point O instead of Point P. In addition, gNodeB i2 and gNodeB i5 are also not aware of the device at Point P and, consequently, they will miss the SRS transmission from the device because both gNodeB i2 and gNodeB i5 are not monitoring the direction at the time when the LPHAP device 204 is transmitting.

The other RRC SRS resource parameters, which are device's location-dependent, include the uplink RRC SRS resource transmission power control. Similar to the spatial relation issue, the SRS resource power-control parameters may vary from the ones prior to the cell reselection.

Cell reselection is the mechanism used to support mobility for LPHAP devices operating in the RRC Idle and RRC Inactive states. In order to find the best cell to camp on, the LPHAP device (or UE) typically first searches for synchronization signal blocks (SSBs) transmitted by a base station. The SSB may include a primary synchronization signal (PSS), a secondary synchronization signal (SSS), and physical broadcast channel (PBCH) (which may contain the master information block (MIB)). From the MIB, the initial downlink (DL) bandwidth part (BWP) may be established, and parameters to establish Control Resource Set 0 (CORESET #0) may also be obtained, which is used to configure the resources used for physical downlink control channel (PDCCH) (which carries downlink control information (DCI)). The DCI may schedule resources for a physical downlink shared channel (PDSCH). The PDSCH may carry the system information block (SIB). The SSB enables the UE to synchronize with the base station and establish connection with the base station for communications.

Unlike SSB, a sounding reference signal (SRS) for positioning is an uplink reference signal transmitted by an LPHAP device to the serving and neighboring cellular base station gNodeBs, which is used to determine the geographical position of the device. The SRS is configured using one or more positioning SRS resource sets, where each set is a collection of one or more SRS resources configured for the purposes of positioning. It is worth noting that an SRS resource corresponds to an SRS beam.

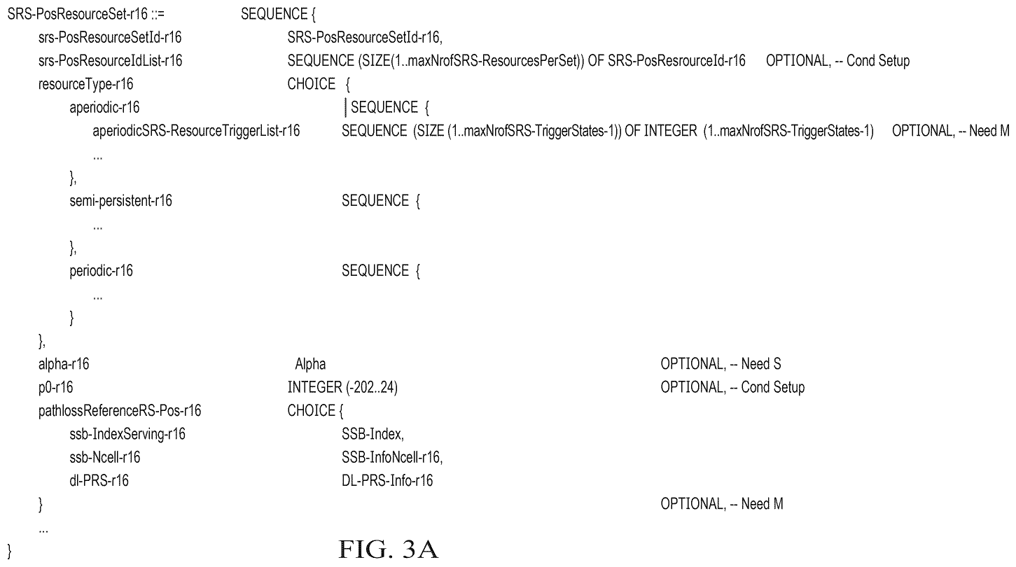

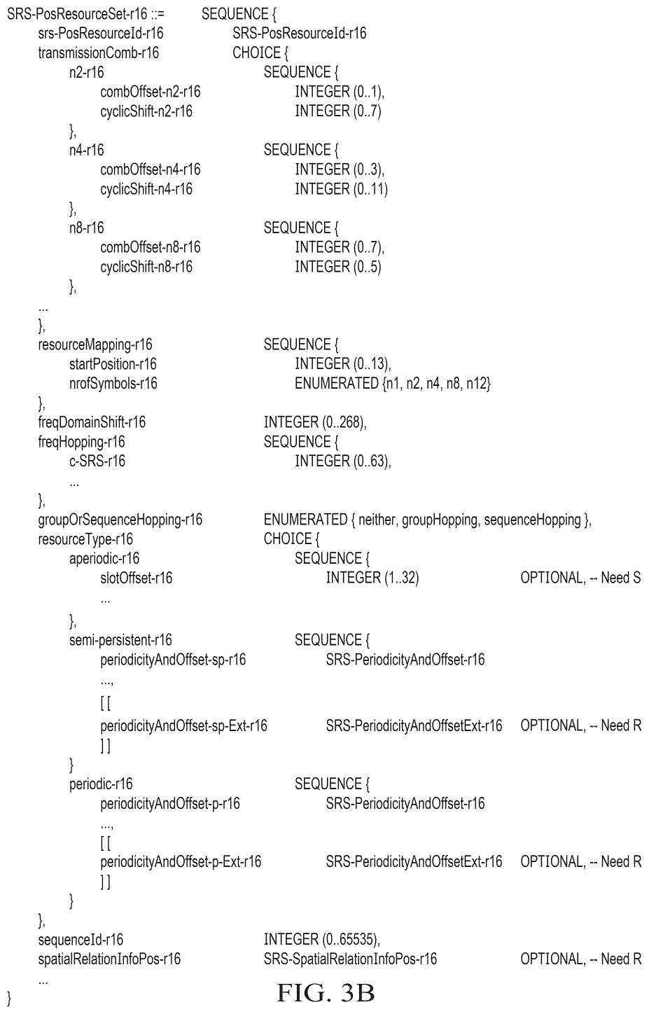

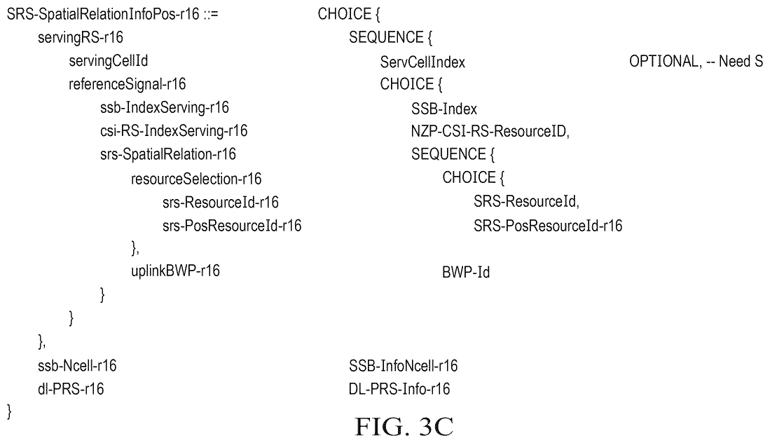

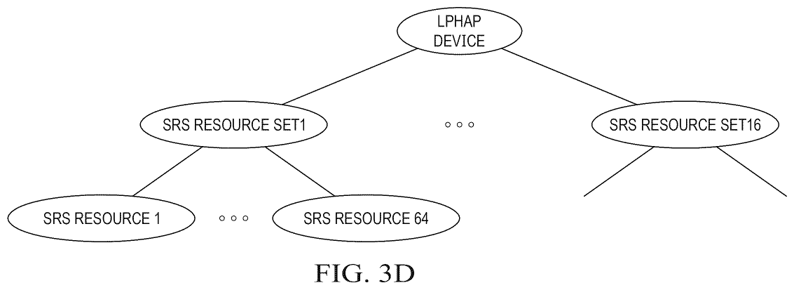

In order to support positioning for an LPHAP device, FIG. 3A shows the RRC parameter structure SRS-PosResourceSet-r16, which is written in the Abstract Syntax Notation One (ASN.1) code in the RRC specification (refer to Clause 6.3, 3GPP TS 38.331 version 17.4.0) and is utilized to configure an SRS resource set.

In the SRS-PosResourceSet-r16 parameter structure, alpha-r16, po-r16 and pathlossReferenceRS-Pos-r16 are the SRS resource specific power-control parameters, which are common to all SRS resources belonging to the same resource set. The pathlossReferenceRS-Pos-r16 parameter indicates the downlink reference signal which may be used for pathloss estimation by the LPHAP device. The type of downlink reference signal may include an SSB (Signal Synchronization Block) of the serving/neighboring cell, or a downlink Positioning Reference Signal (PRS) of the serving/neighboring cell. An SSB includes the Primary Synchronization Signal (PSS), the Secondary Synchronization Signal (SSS), and the Physical Broadcast Channel (PBCH); in the art, an SSB block may also be known as an SS/PBCH block.

The alpha-r16 and po-r16 parameters are used by the LPHAP device to compute the SRS transmission power according to the uplink open-loop power control expression specified in Clause 7.3, 3GPP TS 38.213, which is

$${P}_{SRS , b , f , c} ( i , {q}_{s} ) = min \{ \begin{matrix}{P}_{CMAX , f , c} ( i ) , \\ {P}_{O \_ SRS , b , f , c} ( {q}_{s} ) + 10 {log}_{10} ( {2}^{μ} \cdot {M}_{SRS , b , f , c} ( i ) ) + {α}_{SRS , b , f , c} ( {q}_{s} ) \cdot {PL}_{b , f , c} ( {q}_{d} )\end{matrix} \}$$

dBm

Where
P_{CMAX,f,c}(i) is the device configured maximum allowed output power for carrier f of serving cell c in SRS transmission occasion i;
P_{O_SRS,b,f,c}(i, qₛ) is the nominal device transmit power representing the transmit power per physical resource block, which is configured using po within the SRS-PosResourceSet-r16 parameter structure;
M_{SRS,b,f,c}(i) is an SRS bandwidth expressed in number of physical resource blocks for SRS transmission occasion i;

α_{SRS,b,f,c}(qₛ) represents the fractional-power control multiplier, which is configured using the alpha parameter within the SRS-PosResourceSet-r16 parameter structure;
PL_{b,f,c}(q_{d}) represents the path loss measured by the device using the downlink reference signal resource (with index “q_{d}”) provided by the pathlossReferenceRS-Pos-r16 parameter associated with SRS resource set qₛ.

FIG. 3B shows, within an SRS resource set, the RRC parameter structure SRS-PosResource-r16, which is written in ASN.1 code in the RRC specification (refer to Clause 6.3, 3GPP TS 38.331 version 17.4.0) and is utilized to configure every SRS resource for positioning.

The SRS resource parameter spatialRelationInfoPos-r16 holds the reference signal in which the LPHAP device transmits the configured positioning SRS resources using the spatial direction of the reference signal. For instance, if a spatial relation between a positioning SRS resource and SSB is configured, the LPHAP device transmits RS on the positioning SRS resource using the same beam (or spatial domain transmission filter) as the beam it used to receive the SSB. Other than SSB, CSI-RS, downlink PRS, or non-positioning SRS may act as a reference signal, establishing a one-to-one spatial relation with a positioning SRS resource.

The SRS-SpatialRelationInfoPos-r16 parameter in ASN.1 code, which is used to configure the spatial relation between a positioning SRS resource and a reference signal, is presented in FIG. 3C.

As explained above, the RRC parameter structures SRS-PosResourceSet-r16 and SRS-PosResource-r16, can be used to configure an LPHAP device with one or more SRS configurations for positioning. Each SRS configuration includes one SRS resource set, which in turn can include maximally 64 SRS resources for positioning, leading to a multi-tiered configuration structure as illustrated in FIG. 3D. More than one set can be simultaneously configured (up to 16 SRS resource sets) if the device has multiple antenna panels.

As mentioned above, some parameters are configured at the SRS resource set level while other parameters are configured at the SRS resource level. As such, the parameters of the RRC SRS-PosResourceSet-r16 and SRS-PosResource-r16 can be categorized into two taxonomic classes, namely device's location-independent and device's location-dependent parameters. For the latter, the location-dependent parameters are affected by the movement and rotation of the LPHAP device.

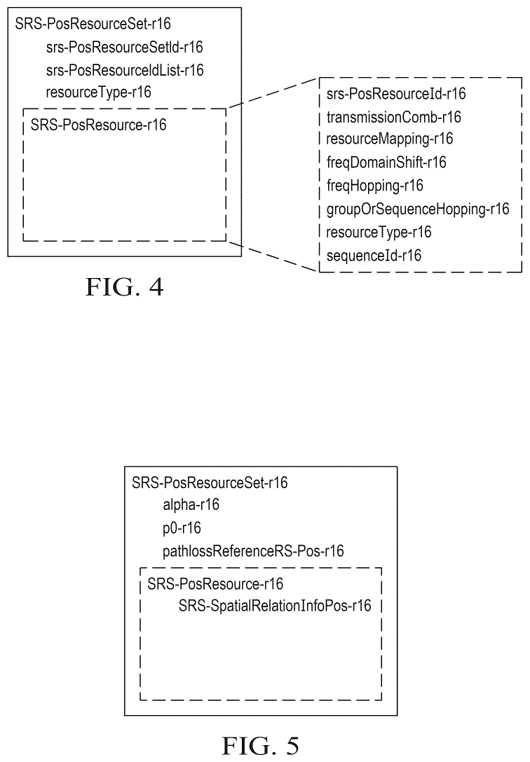

The former class of parameters is commonly configured across cells in the positioning validity area. In other words, once these location-independent parameters are configured for an LPHAP device, the parameter values are applicable (or valid) across all or a subset of the cells in the positioning validity area. As such, it is not necessary to reconfigure such parameters as long as the LPHAP device is moving within the positioning validity area. The device's location-independent parameters are listed in FIG. 4.

The latter class of parameters (e.g., show in FIG. 5) varies with the motion and rotation of the LPHAP device. Such parameters include spatialRelationInfoPos-r16, which is a parameter of the SRS-PosResource-r16, and the pathlossReferenceRS-Pos-r16, alpha-r16 and po-r16 parameters belong to the SRS-PosResourceSet-r16.

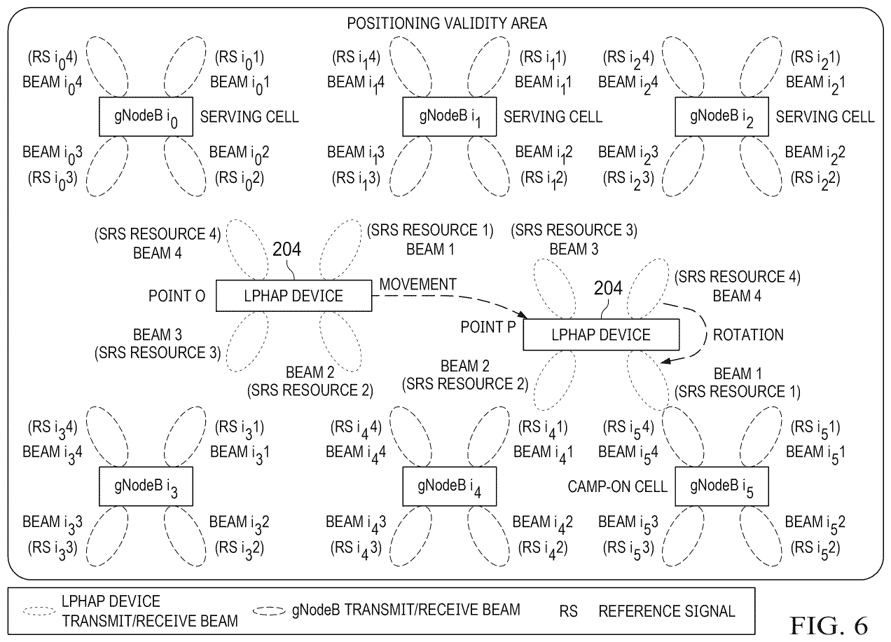

When the SRS-SpatialRelationInfoPos-r16 parameter of an SRS resource is configured with a reference signal, a one-to-one spatial relation is established between the reference signal and the SRS resource. This means the LPHAP device transmits reference signal(s) on the SRS resource using the same beam (or a spatial domain transmission filter) as it used to receive the downlink reference signal. Due to movements and rotations of the LPHAP device, the spatial relation configuration no longer holds (e.g., as shown in FIG. 2). As the trajectory of the LPHAP device is not known in advance and to support device movements and rotations within the positioning validity area without reconfiguring positioning SRS resources, one potential solution to configure one-to-many spatial relations in the positioning validity area in one embodiment. This means, each positioning SRS resource within the SRS resource set is associated with all (or a subset) of the reference signals transmitted by individual base stations in the positioning validity area. Such a one-to-many spatial relation configuration can be realized using a bitmap (e.g., 96 bits for the configuration used as shown in FIG. 6) or a list of indices.

Assuming a lattice or grid network topology similar to FIG. 2, the technique behind the one-to-many spatial relation configuration method embodiment is illustrated in FIG. 6. Initially, the LPHAP device 204 is located at Point O, which is served by gNodeB i0 (in cell i0). As an example, it is assumed that the LPHAP device 204 has one antenna panel and so the serving gNodeB i0 configures the LPHAP device 204 with one SRS resource set for the purpose of positioning, which in turn comprises four positioning SRS resources. Each positioning SRS resource is configured with all the spatial relations of individual gNodeBs in the positioning validity area as presented in Table 2 below. Only one spatial relation is selected for each SRS resource within the SRS resource set based on the best or the strongest downlink reference signal measurements (e.g., reference signal received power (RSRP)). As such, reference signals i13, i44, i31 and i02 are selected to provide spatial relations for SRS Resource 1, SRS Resource 2, SRS Resource 3, and SRS Resource 4, respectively, i13 corresponds to the third reference signal generated by gNodeB i1, i44 corresponds to the fourth reference signal generated by gNodeB i4, and i31 is the first reference signal generated by gNodeB i3, and i02 is the second reference signal generated by gNodeB i0. A typical example of i13, i44, i31 and i02 can be SS/PBCH Block Index 3 of gNodeB i1, SS/PBCH Block Index 4 of gNodeB i4, and so forth.

As illustrated in FIG. 6, each of the four positioning SRS resources is transmitted in a different beam which is steered towards the intended gNodeB. That is, the LPHAP device 204 transmits RSs on SRS Resource 1 in the uplink Beam 1 to gNodeB i1, SRS Resource 2 in the uplink Beam 2 to gNodeB i4, SRS Resource 3 in the uplink Beam 3 to gNodeB i3, and SRS Resource 4 in the uplink Beam 4 to gNodeB i0. Applying beam correspondence, the uplink Beam 1 is the same as the beam the LPHAP device 204 used to receive the downlink reference signal i13, the uplink Beam 2 is the same as the beam to receive the downlink reference signal i44, the uplink Beam 3 is the same as the beam to receive the downlink reference signal i31, and the uplink Beam 4 is the same as the beam to receive the downlink reference signal i02. Although each positioning SRS resource is configured with all the spatial relations of individual gNodeBs in the positioning validity area (see Table 2), only one spatial relation is selected for each SRS resource within the SRS resource set based on the best or strongest downlink reference signal measurements (e.g., reference signal received power (RSRP)). In addition, each SRS resource can be configured with different timing (i.e., resourceMapping-r16-startPosition-r16 is configured differently for each SRS resource), ensuring each resource is transmitted in different OFDM symbols.

TABLE 2
An Exemplary One-to-Many Spatial Relation
Configuration for Positioning SRS Resources

| Base | | | | |
|---|---|---|---|---|
| Station | SRS Resource 1 | SRS Resource 2 | SRS Resource 3 | SRS Resource 4 |
| gNodeB | Reference | Reference Signals: | Reference Signals: | Reference |
| i₀ | Signals: i₀, i₀2 | i₀1, i₀2, i₀3, i₀4 | i₀1, i₀2, i₀3, i₀4 | Signals: i₀1, i₀2, |
| | i₀, i₀ | | | i₀3, i₀4 |
| gNodeB | Reference | Reference Signals: | Reference Signals: | Reference |
| i₁ | Signals: i₁1, i₁2, | i₁1, i₁2, i₁3, i₁4 | i₁1, i₁2, i₁3, i₁4 | Signals: i₁1, i₁2, |
| | i₁3, i₁4 | | | i₁3, i₁4 |
| gNodeB | Reference | Reference Signals: | Reference Signals: | Reference |
| i₂ | Signals: i₂1, i₂2, | i₂1, i₂2, i₂3, i₂4 | i₂1, i₂2, i₂3, i₂4 | Signals: i₂1, i₂2, |
| | i₂3, i₂4 | | | i₂3, i₂4 |
| gNodeB | Reference | Reference Signals: | Reference Signals: | Reference |
| i₃ | Signals: i₃1, 1i₃2, | i₃1, i₃2, i₃3, i₃4 | i₃1, i₃2, i₃3, i₃4 | Signals: i₃1, i₃2, |
| | i₃3, i₃4 | | | i₃3, i₃4 |
| gNodeB | Reference | Reference Signals: | Reference Signals: | Reference |
| i₄ | Signals: i₄1, i₄2, | i₄1, i₄2, i₄3, i₄4 | i₄1, i₄2, i₄3, i₄4 | Signals: i₄1, i₄2, |
| | i₄3, i₄4 | | | i₄3, i₄4 |
| gNodeB | Reference | Reference Signals: | Reference Signals: | Reference |
| i₅ | Signals: i₅1, i₅2, | i₅1, i₅2, i₅3, i₅4 | i₅1, i₅2, i₅3, i₅4 | Signals: i₅1, i₅2, |
| | i₅3, i₅4 | | | i₅3, i₅4 |

At a later time instant, the LPHAP device 204 moves to Point P. It performs cell reselection, and subsequently, camps on Cell i5 as shown in FIG. 6. As the LPHAP device 204 is still within the positioning validity area, no SRS reconfiguration is needed for the LPHAP device 204. Thus, the LPHAP device 204 can retain the SRS configuration (including the individual transmit beam direction corresponding to SRS Resource 1, SRS Resource 2, SRS Resource 3, and SRS Resource 4), which is first obtained when the LPHAP device 204 is located at Point O. Not only has the location of the LPHAP device 204 changed, but also the LPHAP device 204 has been rotated as indicated by the direction of Beam 1 at Point P. As soon as the LPHAP device 204 camps on Cell i5, it uses the transmit beam corresponding to the four configured positioning SRS resources as the receive beam to detect and measure any of the reference signals which configured to provide spatial relations to the positioning SRS resources as presented in Table 2. This means, the LPHAP device 204 should be able to detect reference signals i54, i41, i12 and i23 (along with other reference signals) in Beam 1, Beam 2, Beam 3 and Beam 4, respectively. If the reference signal measurement (e.g., RSRP) in each of the corresponding beams is above a threshold (or can be accurately measured), then the LPHAP device 204 can transmit reference signals on SRS Resources. The SRS Resources may include SRS Resource 1 in uplink Beam 1 to gNodeB i5, SRS Resource 2 in uplink Beam 2 to gNodeB i4, SRS Resource 3 in uplink Beam 3 to gNodeB i1, and SRS Resource 4 in uplink Beam 4 to gNodeB i2; otherwise it attempts to perform a blind search for a downlink reference signal (e.g., SS/PBCH) transmitted by gNodeBs adjoining the camp-on cell or stops the transmission of the positioning SRS resource corresponding to the reference signal in which it cannot accurately measure. Prior to transmitting reference signals on SRS Resource 1, SRS Resource 2, SRS Resource 3, and SRS Resource 4, the LPHAP device 204 signals to the camp-on cell so that gNodeB i5 can allocate resources (e.g., time and frequency, SRS sequence identity) for SRS Resource 1; gNodeB i5 will in turn notify gNodeB i4, gNodeB i1 and gNodeB i2 to reserve resources for SRS Resource 2, SRS Resource 3, and SRS Resource 4, respectively. It may be inefficient use of resources if they are preconfigured and reserved beforehand since the LPHAP device's trajectory is unknown. The signaling can be simple since a complete SRS reconfiguration is not required as the location-independent parameters of the device are commonly configured across the cells in the positioning validity area. Consequently, it is not necessary for the gNodeB i5 to send the complete reconfigured SRS resources to the LPHAP device 204. Regarding the uplink signaling from the LPHAP device 204 to gNodeB i5, the payload of the signaling of the device can be carried in Message 3 of the legacy four-step random access procedure or Message A of the two-step random access. Alternatively, the uplink signaling payload can be carried using preconfigured uplink resources or preconfigured PUSCH resources, which are sent through paging messages or broadcast in system information by gNodeB.

A viable reference signal, which can be used to configure spatial relations for SRS resources, includes SSB, channel state information (CSI)-RS, downlink PRS, TRS, or non-positioning SRS.

Instead of configuring one-to-many spatial relations, it is feasible to reuse the legacy Release-17 one-to-one spatial relation configuration in which the LPHAP device 204 first obtains from the serving cell in another embodiment. As such, the LPHAP device 204 attempts to measure those reference signals (and using the same or existing beam in the uplink transmission direction as the receive beam), which are configured to provide the spatial relation to the positioning SRS resources in the serving cell prior to moving to another location. The device only transmits reference signal(s) on the corresponding SRS resources from which the reference signal measurement is above a threshold (can be accurately measured). For those reference signals in which it cannot accurately measure or the measurement is below a threshold, the LPHAP device 204 performs a blind search for a downlink reference signal (e.g., an SS/PBCH block) using the existing uplink beam as the receive beam. If such a reference signal is found and the measurement is above a threshold (or can be accurately measured), then the LPHAP device 204 transmits reference signal(s) on the corresponding SRS resource. Otherwise, the LPHAP device 204 may choose to perform a receive beam sweep to detect and measure a downlink reference signal; if the reference signal can be accurately measured or the measurement is above a threshold, then it may adjust its current receive beam and transmits reference signal(s) on the SRS resource using the same beam as it is used to receive the downlink reference signal (e.g., SS/PBCH block index) else it stops transmitting reference signal(s) on the SRS resource.

Even though the illustration in FIG. 6 shows four beams generated by the LPHAP device 204 and also four beams by the individual gNodeBs, the configuration method is applicable to an arbitrary number of beams formed by the device and the gNodeB; for instance, one omnidirectional beam for the LPHAP device 204 and individual gNodeBs.

As for SRS transmission power control, the value of the nominal transmit power P_{O_SRS,b,f,c}(i, qₛ) and fractional power-control multiplier α_{SRS,b,f,c}(qₛ) can be commonly configured across the cells within the positioning validity area for individual LPHAP devices in one embodiment. In other words, the LPHAP device is configured with common po-r16 and alpha-r16 values across the cells within the positioning validity area. The LPHAP device first obtains the configured po-r16 and alpha-r16 values from the serving cell. For instance, irrespective of the location of the LPHAP device in the positioning validity area, be it at Point O or Point P (e.g., in FIG. 6), the same po-r16 and alpha-r16 values are applied to set the transmission power for SRS Resource 1, SRS Resource 2, SRS Resource 3, and SRS Resource 4. It is important to note that individual LPHAP devices can be configured with different po and alpha values even though they are located in the same positioning validity area; the configured po-r16 and alpha-r16 values for individual LPHAP devices can remain the unchanged as the device is moving within the positioning validity area.

In another embodiment, the nominal transmit power P_{O_SRS,b,f,c}(i, qₛ) and fractional power-control multiplier α_{SRS,b,f,c}(qₛ) can be configured on a cell-by-cell (i.e., per-cell) basis. As such, the LPHAP device selects the po and alpha values based the camp-on cell. An example of such per-cell configurations is presented in Table 3. Referring to FIG. 6, the LPHAP device 204 at Point O receives the cell-by-cell configuration from the serving cell (gNodeB i0) and the configured po and ao values are chosen. When the LPHAP device 204 moves to the camp-on Cell i5 at Point P, it selects the configured po and alpha values corresponding to p5 and a5, respectively.

TABLE 3
Cell-by-Cell Configurations for the Nominal Transmit
Power and Fractional Power-Control Multiplier

| Cell Identity | P₀ | α |
|---|---|---|
| gNodeB i₀ | p0 | a0 |
| gNodeB i₁ | p1 | a1 |
| gNodeB i₂ | p2 | a2 |
| gNodeB i₃ | p3 | a3 |
| gNodeB i₄ | p4 | a4 |
| gNodeB i₅ | p5 | a5 |

With regard to the pathloss, a one-to-many pathloss configuration, which is similar to the one-to-many spatial relation configuration, can be applied. Unlike the spatial relation, the pathloss reference signal is configured at the SRS resource set level. This implies that all the SRS resources within the resource set share the same pathloss reference signal as well as the pathloss estimation. In the lattice or grid network topology as shown in FIG. 6, it is sufficient to configure the LPHAP device 204 with one pathloss reference signal although each positioning SRS resource within the set is transmitted to different gNodeBs, but the pathloss between the device and the different gNodeBs is almost the same. If multiple pathloss reference signal configurations are needed, then the LPHAP device 204 is configured with multiple SRS resource sets, each with a different pathloss reference signal. However, such a multiple pathloss reference signal configuration leads to higher power consumption, which is not desirable to LPHAP devices.

Referring to FIG. 6, when the LPHAP device is located at Point O, each positioning SRS resource set is configured with all the pathloss reference signals of individual gNodeBs in the positioning validity area as presented in Table 4. Only one pathloss reference is selected for each SRS resource set based on the downlink reference signal measurements (e.g., reference signal received power (RSRP) above a threshold or can be accurately measured). It is also possible to select the best or strongest downlink reference signal measurements. In this example, the downlink reference signal i02 is selected.

Once the LPHAP device 204 moves to Point P, the LPHAP device 204 attempts to detect and measure any of the reference signals configured for pathloss in Cell i5, which is the camp-on cell after cell reselection. The selected pathloss reference signal is i54. If none of measured reference signals satisfy the validity criteria (such as the reference signal cannot be accurately measured), then the UE attempts to measure pathloss reference signals from neighboring cells adjoining the camp-on cell.

TABLE 4
An exemplary One-to-Many Pathloss Reference Signal
Configuration for SRS Resource Set for positioning

| Base Station | SRS Resource Set |
|---|---|
| gNodeB i₀ | Reference Signals: i₀1, i₀2, i₀3, i₀4 |
| gNodeB i₁ | Reference Signals: i₁1, i₁2, i₁3, i₁4 |
| gNodeB i₂ | Reference Signals: i₂1, i₂2, i₂3, i₂4 |
| gNodeB i₃ | Reference Signals: i₃1, i₃2, i₃3, i₃4 |
| gNodeB i₄ | Reference Signals: i₄1, i₄2, i₄3, i₄4 |
| gNodeB i₅ | Reference Signals: i₅1, i₅2, i₅3, i₅4 |

In another embodiment, it is feasible to configure a one-to-one pathloss reference signal for each SRS resource set as in the legacy Release-17 pathloss reference signal configuration. As such, the LPHAP device attempts to measure the reference signal (using any of its uplink beams) which is configured to provide a pathloss estimation to the positioning SRS resource set in the serving cell prior to moving to another location. The LPHAP device only transmits reference signal(s) on the positioning SRS resources within the SRS resource set from which the reference signal measurement is above a threshold (can be accurately measured). For the pathloss reference signal in which it cannot accurately measure or the measurement is below a threshold, then the LPHAP device estimates the pathloss from the reference signal resources obtained from the SS/PBCH block transmitted by the camp-on cell gNodeB, where the device uses to obtain the MIB.

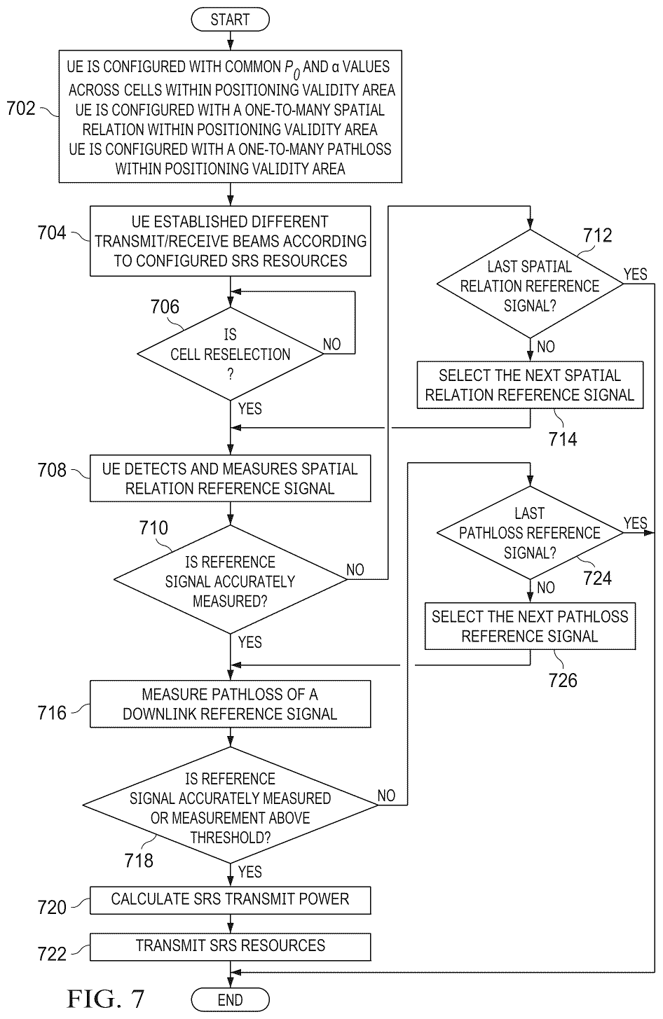

FIG. 7 is a flowchart depicting a one-to-many spatial relation SRS resource configuration method of positioning SRS resources, according to some embodiments. At the operation 702, a UE (e.g., the LPHAP device) is configured with common P_O and ∝ values across cells within positioning validity area. The UE is configured with a one-to-many spatial relation within the positioning validity area. The UE is configured with a one-to-many pathloss within the positioning validity area. At the operation 704, the UE has established different transmit/receive beams according to configured SRS resources. At the operation 706, the UE determines whether cell reselection has occurred. If yes, the UE detects and measures spatial relation reference signal at the operation 708. At the operation 710, the UE determines whether the reference signal is accurately measured. If not, the UE determines whether this is the last spatial relation reference signal at the operation 712. If not, the UE selects the next spatial reference signal at the operation 714 and proceeds to the operation 708. If the reference signal is accurately measured, the UE measures path loss of a downlink reference signal at the operation 716. At the operation 718, the UE determines whether the reference signal is accurately measured or the measurement is above a threshold. If yes, the UE calculates the SRS transmit power at the operation 720 and transmits reference signals on the SRS resources at the operation 722. If the answer to the operation 718 is no, the UE determines whether this is the last pathloss reference signal at the operation 724. If not, the UE selects the next pathloss reference signal and proceeds to the operation 716.

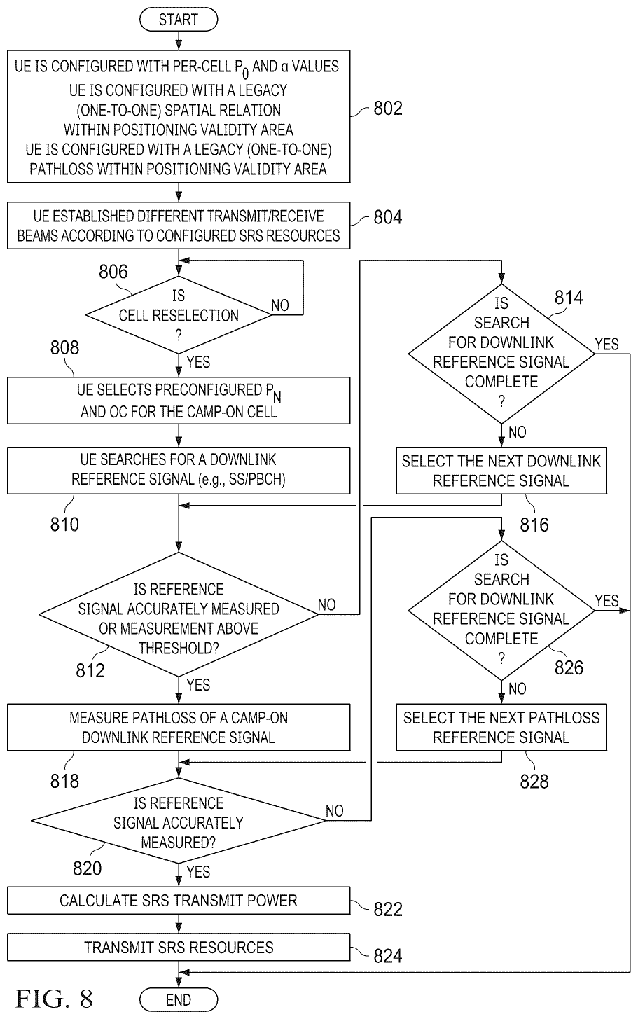

FIG. 8 is flowchart depicting the legacy spatial relation SRS resource configuration method of positioning SRS resources, according to some embodiments. At the operation 802, a UE (e.g., the LPHAP device) is configured with per-cell P_O and ∝ values. The UE is configured with a legacy (one-to-one) spatial relation within the positioning validity area. The UE is configured with a legacy (one-to-one) pathloss within the positioning validity area. At the operation 804, the UE has established different transmit/receive beams according to configured SRS resources. At the operation 806, the UE determines whether cell reselection has occurred. If yes, the UE selects preconfigured P_{O} and ∝ for the camp-on cell at the operation 808. At the operation 810, the UE searches for a downlink reference signal (e.g., SS/PBCH). At the operation 812, the UE determines whether the reference signal is accurately measured or the measurement is above a threshold. If no, the UE determines whether the search for the downlink reference signal is complete at the operation 814. If not, the UE selects the next downlink reference signal at the operation 816 and proceeds to the operation 812. If the answer to the operation 812 is yes, the UE measures the path loss of a camp-on downlink reference signal at the operation 818. At the operation 820, the UE determines whether the reference is accurately measured. If yes, the UE calculates the SRS transmit power at the operation 822 and transmits reference signals on the SRS resources at the operation 824. If the answer to the operation 820 is no, the UE determines whether the search for the downlink reference signal is complete at the operation 826. If not, the UE selects the next pathloss reference signal at the operation 828 and proceeds to the operation 820.

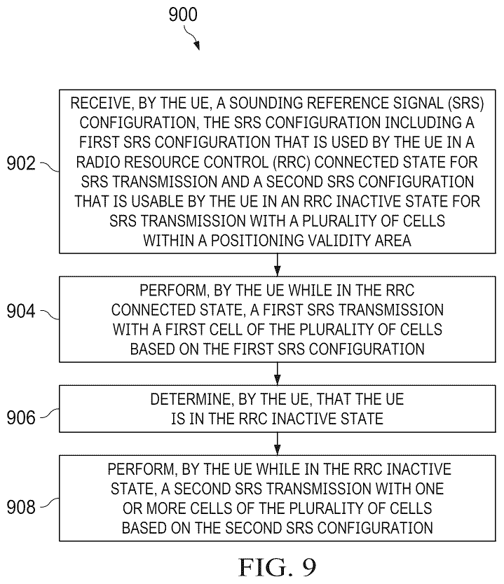

FIG. 9 shows a flow chart of a method goo performed by a UE (e.g., an LPHAP device), according to some embodiments. The UE may include computer-readable code or instructions executing on one or more processors of the UE. Coding of the software for carrying out or performing the method 900 is well within the scope of a person of ordinary skill in the art having regard to the present disclosure. The method 900 may include additional or fewer operations than those shown and described and may be carried out or performed in a different order. Computer-readable code or instructions of the software executable by the one or more processors may be stored on a non-transitory computer-readable medium, such as for example, the memory of the UE. In some embodiments, the method 900 may be performed by one or more of units or modules (e.g., an integrated circuit) of the UE, such as field programmable gate arrays (FPGAs) or application-specific integrated circuits (ASICs).

The method 900 starts at the operation 902, where the UE receives a sounding reference signal (SRS) configuration. The SRS configuration includes a first SRS configuration that is used by the UE in a radio resource control (RRC) connected state for SRS transmission and a second SRS configuration that is usable by the UE in an RRC inactive state for SRS transmission with a plurality of cells within a positioning validity area. At the operation 904, the UE, while in the RRC connected state, performs a first SRS transmission with a first cell of the plurality of cells based on the first SRS configuration. At the operation 906, the UE determines that the UE is in the RRC inactive state. At the operation 908, the UE, while in the RRC inactive state, performs a second SRS transmission with one or more cells of the plurality of cells based on the second SRS configuration.

In some embodiments, the SRS configuration may indicate a pathloss reference signal (RS) for positioning. The UE may determine whether the UE while in the RRC inactive state is able to accurately measure a pathloss using the pathloss RS.

In some embodiments, to perform the second SRS transmission, the UE, while in the RRC inactive state, may calculate a pathloss parameter for power control of the second SRS transmission based on that the pathloss measured using the pathloss RS is above a threshold. The UE may, while in the RRC inactive state, set the pathloss measured using the pathloss RS as the pathloss parameter for the power control of the second SRS transmission based on that the pathloss measured using the pathloss RS is accurately measured.

In some embodiments, to perform the second SRS transmission, the UE, while in the RRC inactive state, may calculating a pathloss parameter for power control of the second SRS transmission using an RS resource from a synchronization signal (SS)/physical broadcast channel (PBCH) block based on that the pathloss measured using the pathloss RS is not accurately measured.

In some embodiments, the UE, while in the RRC inactive state, may determine whether to perform the second SRS transmission over an SRS resource based on whether the UE is able to accurately measure a downlink (DL) RS. The DL RS may have a spatial relation with an SRS resource for positioning, and the DL RS is semi-persistent or periodic.

In some embodiments, the UE may be configured with one or more of: a one-to-many spatial relation in the positioning validity area, or a one-to-many pathloss relation within the positioning validity area.

In some embodiments, the one-to-many spatial relation may comprise: each positioning SRS resource within an SRS resource set being associated with at least a subset of RSs transmitted by individual base stations in the positioning validity area.

In some embodiments, the second SRS configuration may indicate a nominal transmit power parameter and a fractional power-control multiplier parameter for the positioning validity area. To perform the second SRS transmission, the UE, while in the RRC inactive state, may calculate a transmit power for each of multiple SRS resources of the second SRS transmission using the nominal transmit power parameter and the fractional power-control multiplier parameter. The multiple SRS resources may belong to multiple SRS resource sets and may be associated with multiple cells of the plurality of cells within the positioning validity area.

In some embodiments, the UE may be a low-power high accuracy positioning (LPHAP) device.

In some embodiments, the first SRS transmission may correspond to a first beam. The second SRS transmission may correspond to multiple beams.

In some embodiments, the UE may receive a downlink RS from each of multiple cells using a same beam as a transmit beam corresponding to an SRS resource of a corresponding cell. Each of the multiple cells may correspond to respective different transmit beams.

In some embodiments, the SRS configuration may indicate a pathloss reference signal (RS) for the positioning validity area. The UE may calculate a pathloss parameter for power control of the second SRS transmission based on whether the UE in an RRC_INACTIVE state can accurately measure a pathloss using the pathloss RS.

In some embodiments, whether the UE can accurately measure a pathloss using the pathloss RS may be based on whether the pathloss measured using the pathloss RS is above a threshold.

In some embodiments, the UE may set the pathloss measured using the pathloss RS as the pathloss parameter for the power control of the second SRS transmission based on that the pathloss measured using the pathloss RS is accurately measured.

In some embodiments, the UE may calculate the pathloss parameter for the power control of the second SRS transmission using an RS from a synchronization signal (SS)/physical broadcast channel (PBCH) block based on that the pathloss measured using the pathloss RS is not accurately measured.

In some embodiments, the SRS configuration may indicate a spatial relation for the positioning validity area. The spatial relation may be between a downlink (DL) RS and an SRS resource. The UE may determine, while the UE is in an RRC_INACTIVE state, whether to perform the second SRS transmission over the SRS resource based on whether the UE can accurately measure the DL RS.

In some embodiments, the UE may determine, while the UE is in the RRC_INACTIVE state, not to perform the second SRS transmission based on that the UE cannot accurately measure the DL RS.

In some embodiments, the DL RS may be semi-persistent or periodic.

In some embodiments, the SRS configuration may indicate a nominal transmit power parameter and a fractional power-control multiplier parameter for the positioning validity area. The UE may calculate, while the UE is in an RRC_INACTIVE state, a transmit power for the second SRS transmission using the nominal transmit power parameter and the fractional power-control multiplier parameter.

In some embodiments, the determining how to use the SRS configuration for the second SRS transmission may be performed while the UE is in an RRC_INACTIVE state.

In some embodiments, the UE may be a low-power high accuracy positioning (LPHAP) device.

In some embodiments, the plurality of cells covering the positioning validity area may include at least three cells.

In some embodiments, each cell of the plurality of cells covering the positioning validity area may correspond to a different cell identifier (ID).

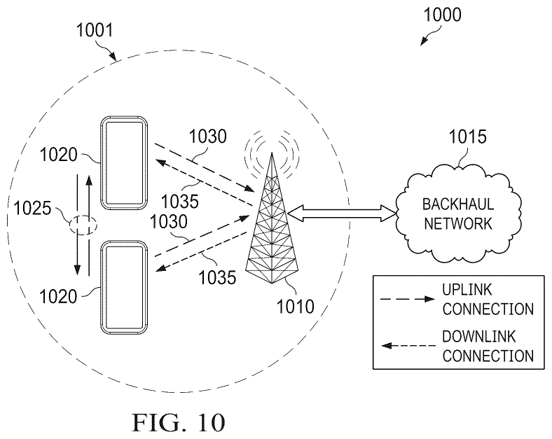

FIG. 10 illustrates an example communications system 1000. Communications system 1000 includes an access node 1010 serving user equipments (UEs) with coverage 1001, such as UEs 1020. In a first operating mode, communications to and from a UE passes through access node 1010 with a coverage area 1001. The access node 1010 is connected to a backhaul network 1015 for connecting to the internet, operations and management, and so forth. In a second operating mode, communications to and from a UE do not pass through access node 1010, however, access node 1010 typically allocates resources used by the UE to communicate when specific conditions are met. Communications between a pair of UEs 1020 can use a sidelink connection (shown as two separate one-way connections 1025). In FIG. 10, the sideline communication is occurring between two UEs operating inside of coverage area 1001. However, sidelink communications, in general, can occur when UEs 1020 are both outside coverage area 1001, both inside coverage area 1001, or one inside and the other outside coverage area 1001. Communication between a UE and access node pair occurs over uni-directional communication links, where the communication links between the UE and the access node are referred to as uplinks 1030, and the communication links between the access node and UE are referred to as downlinks 1035.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

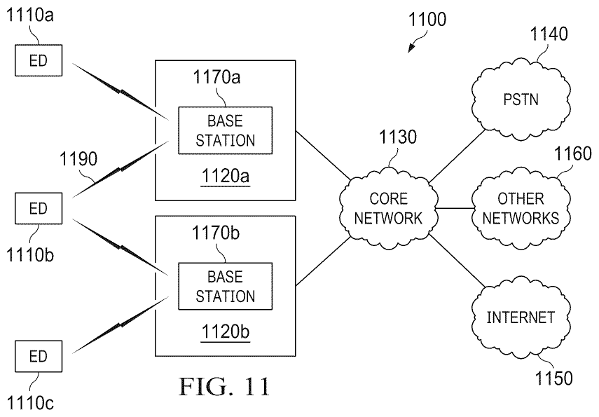

FIG. 11 illustrates an example communication system 1100. In general, the system 1100 enables multiple wireless or wired users to transmit and receive data and other content. The system 1100 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 1101 includes electronic devices (ED) 1110a-1110c, radio access networks (RANs) 1120a-1120b, a core network 1130, a public switched telephone network (PSTN) 1140, the Internet 1150, and other networks 1160. While certain numbers of these components or elements are shown in FIG. 11, any number of these components or elements may be included in the system 1100.

The EDs 1110a-1110c are configured to operate or communicate in the system 1100. For example, the EDs 1110a-1110c are configured to transmit or receive via wireless or wired communication channels. Each ED 1110a-1110c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 1120a-1120b here include base stations 1170a-1170b, respectively. Each base station 1170a-1170b is configured to wirelessly interface with one or more of the EDs 1110a-1110c to enable access to the core network 130, the PSTN 1140, the Internet 1150, or the other networks 1160. For example, the base stations 1170a-1170b may include (or be) one or more of several well-known devices, such as a base transceiver station (BTS), a Node-B (NodeB), an evolved NodeB (eNB), a Next Generation (NG) NodeB (gNB), a gNB centralized unit (gNB-CU), a gNB distributed unit (gNB-DU), a Home NodeB, a Home eNodeB, a site controller, an access point (AP), or a wireless router. The EDs 1110a-1110c are configured to interface and communicate with the Internet 1150 and may access the core network 1130, the PSTN 1140, or the other networks 1160.

In the embodiment shown in FIG. 11, the base station 1170a forms part of the RAN 1120a, which may include other base stations, elements, or devices. Also, the base station 1170b forms part of the RAN 1120b, which may include other base stations, elements, or devices. Each base station 1170a-1170b operates to transmit or receive wireless signals within a particular geographic region or area, sometimes referred to as a “cell.” In some embodiments, multiple-input multiple-output (MIMO) technology may be employed having multiple transceivers for each cell.

The base stations 1170a-1170b communicate with one or more of the EDs 1110a-1110c over one or more air interfaces 1190 using wireless communication links. The air interfaces 1190 may utilize any suitable radio access technology.

It is contemplated that the system 1100 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 1120a-1120b are in communication with the core network 1130 to provide the EDs 1110a-1110c with voice, data, application, Voice over Internet Protocol (VoIP), or other services. Understandably, the RANs 1120a-1120b or the core network 1130 may be in direct or indirect communication with one or more other RANs (not shown). The core network 1130 may also serve as a gateway access for other networks (such as the PSTN 1140, the Internet 1150, and the other networks 1160). In addition, some or all of the EDs 1110a-1110c may include functionality for communicating with different wireless networks over different wireless links using different wireless technologies or protocols. Instead of wireless communication (or in addition thereto), the EDs may communicate via wired communication channels to a service provider or switch (not shown), and to the Internet 150.

Although FIG. 11 illustrates one example of a communication system, various changes may be made to FIG. 11. For example, the communication system 1101 could include any number of EDs, base stations, networks, or other components in any suitable configuration.

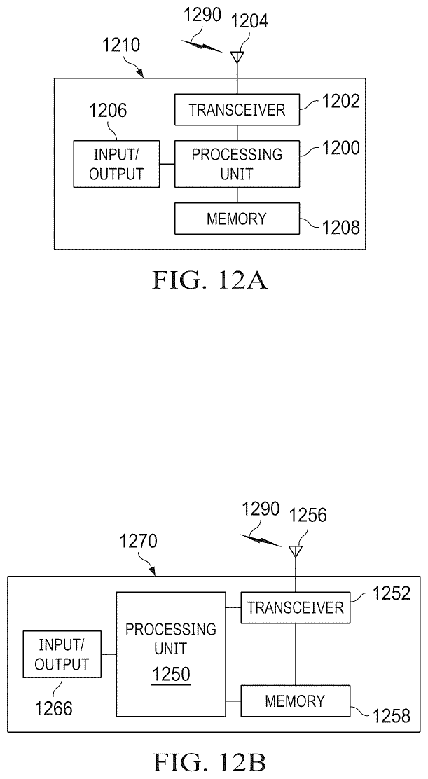

FIGS. 12A and 12B illustrate example devices that may implement the methods and teachings according to this disclosure. In particular, FIG. 12A illustrates an example ED 1210, and FIG. 12B illustrates an example base station 1270. These components could be used in the system 1101 or in any other suitable system.

As shown in FIG. 12A, the ED 1210 includes at least one processing unit 1200. The processing unit 1200 implements various processing operations of the ED 1210. For example, the processing unit 1200 could perform signal coding, data processing, power control, input/output processing, or any other functionality enabling the ED 1210 to operate in the system 1101. The processing unit 1200 also supports the methods and teachings described in more detail above. Each processing unit 1200 includes any suitable processing or computing device configured to perform one or more operations. Each processing unit 1200 could, for example, include a microprocessor, microcontroller, digital signal processor, field programmable gate array, or application specific integrated circuit.

The ED 1210 also includes at least one transceiver 1202. The transceiver 1202 is configured to modulate data or other content for transmission by at least one antenna or NIC (Network Interface Controller) 1204. The transceiver 1202 is also configured to demodulate data or other content received by the at least one antenna 1204. Each transceiver 1202 includes any suitable structure for generating signals for wireless or wired transmission or processing signals received wirelessly or by wire. Each antenna 1204 includes any suitable structure for transmitting or receiving wireless or wired signals. One or multiple transceivers 1202 could be used in the ED 1210, and one or multiple antennas 1204 could be used in the ED 1210. Although shown as a single functional unit, a transceiver 1202 could also be implemented using at least one transmitter and at least one separate receiver.

The ED 1210 further includes one or more input/output devices 1206 or interfaces (such as a wired interface to the Internet 1150). The input/output devices 1206 facilitate interaction with a user or other devices (network communications) in the network. Each input/output device 1206 includes any suitable structure for providing information to or receiving information from a user, such as a speaker, microphone, keypad, keyboard, display, or touch screen, including network interface communications.

In addition, the ED 1210 includes at least one memory 1208. The memory 1208 stores instructions and data used, generated, or collected by the ED 1210. For example, the memory 1208 could store software or firmware instructions executed by the processing unit(s) 1200 and data used to reduce or eliminate interference in incoming signals. Each memory 1208 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 12B, the base station 1270 includes at least one processing unit 1250, at least one transceiver 1252, which includes functionality for a transmitter and a receiver, one or more antennas 1256, at least one memory 1258, and one or more input/output devices or interfaces 1266. A scheduler, which would be understood by one skilled in the art, is coupled to the processing unit 1250. The scheduler could be included within or operated separately from the base station 1270. The processing unit 1250 implements various processing operations of the base station 1270, such as signal coding, data processing, power control, input/output processing, or any other functionality. The processing unit 1250 can also support the methods and teachings described in more detail above. Each processing unit 1250 includes any suitable processing or computing device configured to perform one or more operations. Each processing unit 1250 could, for example, include a microprocessor, microcontroller, digital signal processor, field programmable gate array, or application specific integrated circuit.

Each transceiver 1252 includes any suitable structure for generating signals for wireless or wired transmission to one or more EDs or other devices. Each transceiver 1252 further includes any suitable structure for processing signals received wirelessly or by wire from one or more EDs or other devices. Although shown combined as a transceiver 1252, a transmitter and a receiver could be separate components. Each antenna 1256 includes any suitable structure for transmitting or receiving wireless or wired signals. While a common antenna 1256 is shown here as being coupled to the transceiver 1252, one or more antennas 1256 could be coupled to the transceiver(s) 1252, allowing separate antennas 1256 to be coupled to the transmitter and the receiver if equipped as separate components. Each memory 1258 includes any suitable volatile or non-volatile storage and retrieval device(s). Each input/output device 1266 facilitates interaction with a user or other devices (network communications) in the network. Each input/output device 1266 includes any suitable structure for providing information to or receiving/providing information from a user, including network interface communications.

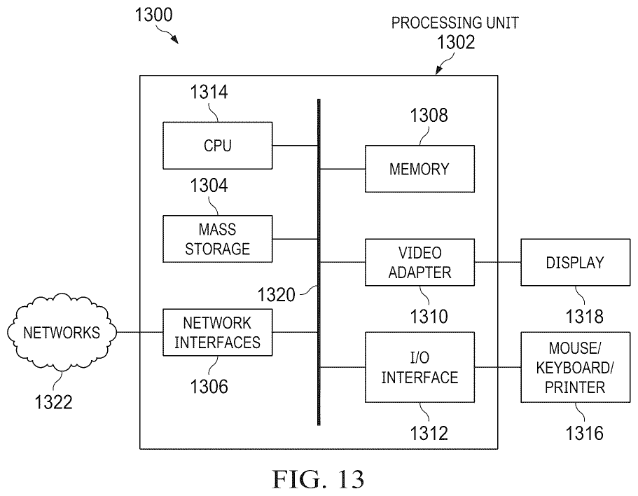

FIG. 13 is a block diagram of a computing system 1300 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 1300 includes a processing unit 1302. The processing unit includes a central processing unit (CPU) 1314, memory 1308, and may further include a mass storage device 1304, a video adapter 1310, and an I/O interface 1312 connected to a bus 1320.

The bus 1320 may be one or more of any type of several bus architectures including a memory bus or memory controller, a peripheral bus, or a video bus. The CPU 1314 may comprise any type of electronic data processor. The memory 1308 may comprise any type of non-transitory system memory such as static random access memory (SRAM), dynamic random access memory (DRAM), synchronous DRAM (SDRAM), read-only memory (ROM), or a combination thereof. In an embodiment, the memory 1308 may include ROM for use at boot-up, and DRAM for program and data storage for use while executing programs.

The mass storage 1304 may comprise any type of non-transitory storage device configured to store data, programs, and other information and to make the data, programs, and other information accessible via the bus 1320. The mass storage 1304 may comprise, for example, one or more of a solid state drive, hard disk drive, a magnetic disk drive, or an optical disk drive.

The video adapter 1310 and the I/O interface 1312 provide interfaces to couple external input and output devices to the processing unit 1302. As illustrated, examples of input and output devices include a display 1318 coupled to the video adapter 1310 and a mouse, keyboard, or printer 1316 coupled to the I/O interface 1312. Other devices may be coupled to the processing unit 1302, and additional or fewer interface cards may be utilized. For example, a serial interface such as Universal Serial Bus (USB) (not shown) may be used to provide an interface for an external device.

The processing unit 1302 also includes one or more network interfaces 1306, which may comprise wired links, such as an Ethernet cable, or wireless links to access nodes or different networks. The network interfaces 1306 allow the processing unit 1302 to communicate with remote units via the networks. For example, the network interfaces 1306 may provide wireless communication via one or more transmitters/transmit antennas and one or more receivers/receive antennas. In an embodiment, the processing unit 1302 is coupled to a local-area network 1322 or a wide-area network for data processing and communications with remote devices, such as other processing units, the Internet, or remote storage facilities.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a performing unit or module, a generating unit or module, an obtaining unit or module, a setting unit or module, an adjusting unit or module, an increasing unit or module, a decreasing unit or module, a determining unit or module, a modifying unit or module, a reducing unit or module, or a selecting unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed is:

1. A method, comprising:
receiving, by a user equipment (UE), a sounding reference signal (SRS) configuration, the SRS configuration including a first SRS configuration that is used by the UE in a radio resource control (RRC) connected state for SRS transmission and a second SRS configuration that is usable by the UE in an RRC inactive state for SRS transmission with a plurality of cells within a positioning validity area;
performing, by the UE while in the RRC connected state, a first SRS transmission with a first cell of the plurality of cells based on the first SRS configuration;
determining, by the UE, that the UE is in the RRC inactive state; and
performing, by the UE while in the RRC inactive state, a second SRS transmission with one or more cells of the plurality of cells based on the second SRS configuration.

2. The method of claim 1, the SRS configuration indicating a pathloss reference signal (RS) for positioning, and the method further comprising:
determining whether the UE while in the RRC inactive state is able to accurately measure a pathloss using the pathloss RS.

3. The method of claim 2, the performing, by the UE while in the RRC inactive state, the second SRS transmission comprising:
calculating, by the UE while in the RRC inactive state, a pathloss parameter for power control of the second SRS transmission based on that the pathloss measured using the pathloss RS is above a threshold; and
setting, by the UE while in the RRC inactive state, the pathloss measured using the pathloss RS as the pathloss parameter for the power control of the second SRS transmission based on that the pathloss measured using the pathloss RS is accurately measured.

4. The method of claim 2, the performing, by the UE while in the RRC inactive state, the second SRS transmission comprising:
calculating, by the UE while in the RRC inactive state, a pathloss parameter for power control of the second SRS transmission using an RS resource from a synchronization signal (SS)/physical broadcast channel (PBCH) block based on that the pathloss measured using the pathloss RS is not accurately measured.

5. The method of claim 1, further comprising:
determining, by the UE while in the RRC inactive state, whether to perform the second SRS transmission over an SRS resource based on whether the UE is able to accurately measure a downlink (DL) RS, wherein the DL RS has a spatial relation with an SRS resource for positioning, and the DL RS is semi-persistent or periodic.

6. The method of claim 5, wherein the UE is configured with a one-to-many pathloss relation within the positioning validity area.

7. The method of claim 5, wherein the UE is configured with a one-to-many spatial relation, the one-to-many spatial relation comprising: each positioning SRS resource within an SRS resource set being associated with at least a subset of RSs transmitted by individual base stations in the positioning validity area.

8. The method of claim 1, the second SRS configuration indicating a nominal transmit power parameter and a fractional power-control multiplier parameter for the positioning validity area, the performing, by the UE while in the RRC inactive state, the second SRS transmission comprising:
calculating, by the UE while in the RRC inactive state, a transmit power for each of multiple SRS resources of the second SRS transmission using the nominal transmit power parameter and the fractional power-control multiplier parameter, wherein the multiple SRS resources belong to multiple SRS resource sets and are associated with multiple cells of the plurality of cells within the positioning validity area.

9. The method of claim 1, wherein the UE is a low-power high accuracy positioning (LPHAP) device.

10. The method of claim 1, the first SRS transmission corresponding to a first beam, and the second SRS transmission corresponding to multiple beams.

11. The method of claim 1, the method further comprising:
receiving, by the UE, downlink RSs from multiple cells using multiple receive beams corresponding to respective transmit beams of the multiple cells, a receive beam for each cell being same as a transmit beam corresponding to the each cell.

12. A user equipment (UE), comprising:
at least one processor, and
a non-transitory computer readable storage medium storing programming, the programming including instructions that, when executed by the at least one processor, cause the UE to perform:
receiving a sounding reference signal (SRS) configuration, the SRS configuration including a first SRS configuration that is used by the UE in a radio resource control (RRC) connected state for SRS transmission and a second SRS configuration that is usable by the UE in an RRC inactive state for SRS transmission with a plurality of cells within a positioning validity area;
performing, by the UE while in the RRC connected state, a first SRS transmission with a first cell of the plurality of cells based on the first SRS configuration;
determining that the UE is in the RRC inactive state; and
performing, by the UE while in the RRC inactive state, a second SRS transmission with one or more cells of the plurality of cells based on the second SRS configuration.

13. The UE of claim 12, the SRS configuration indicating a pathloss reference signal (RS) for positioning, and the instructions, when executed by the at least one processor, further causing the UE to perform:
determining whether the UE while in the RRC inactive state is able to accurately measure a pathloss using the pathloss RS.

14. The UE of claim 13, the performing, by the UE while in the RRC inactive state, the second SRS transmission comprising:
calculating, by the UE while in the RRC inactive state, a pathloss parameter for power control of the second SRS transmission based on that the pathloss measured using the pathloss RS is above a threshold; and
setting, by the UE while in the RRC inactive state, the pathloss measured using the pathloss RS as the pathloss parameter for the power control of the second SRS transmission based on that the pathloss measured using the pathloss RS is accurately measured.

15. The UE of claim 13, the performing, by the UE while in the RRC inactive state, the second SRS transmission comprising:
calculating, by the UE while in the RRC inactive state, a pathloss parameter for power control of the second SRS transmission using an RS resource from a synchronization signal (SS)/physical broadcast channel (PBCH) block based on that the pathloss measured using the pathloss RS is not accurately measured.

16. The UE of claim 12, the instructions, when executed by the at least one processor, further causing the UE to perform:
determining, by the UE while in the RRC inactive state, whether to perform the second SRS transmission over an SRS resource based on whether the UE is able to accurately measure a downlink (DL) RS, wherein the DL RS has a spatial relation with an SRS resource for positioning, and the DL RS is semi-persistent or periodic.

17. The UE of claim 16, wherein the UE is configured with a one-to-many pathloss relation within the positioning validity area.

18. The UE of claim 16, wherein the UE is configured with a one-to-many spatial relation in the positioning validity area, the one-to-many spatial relation comprising: each positioning SRS resource within an SRS resource set being associated with at least a subset of RSs transmitted by individual base stations in the positioning validity area.

19. The UE of claim 12, the second SRS configuration indicating a nominal transmit power parameter and a fractional power-control multiplier parameter for the positioning validity area, the performing, by the UE while in the RRC inactive state, the second SRS transmission comprising:
calculating, by the UE while in the RRC inactive state, a transmit power for each of multiple SRS resources of the second SRS transmission using the nominal transmit power parameter and the fractional power-control multiplier parameter, wherein the multiple SRS resources belong to multiple SRS resource sets and are associated with multiple cells of the plurality of cells within the positioning validity area.

20. The UE of claim 12, the instructions, when executed by the at least one processor, further causing the UE to perform:
receiving downlink RSs from multiple cells using multiple receive beams corresponding to respective transmit beams of the multiple cells, a receive beam for each cell being same as a transmit beam corresponding to the each cell.
